(19) United States
(12) Patent Application Publication
(10) Pub. No.: US 2026/0194088 A1
(43) Pub. Date: Jul. 9, 2026

(54) SHUTTER CLIP APPARATUSES, ASSEMBLIES AND METHODS

(71) Applicant: Don Huizenga, Anoka, MN (US)

(72) Inventor: Don Huizenga, Anoka, MN (US)

(21) Appl. No.: 19/133,131

(22) PCT Filed: Feb. 5, 2024
(86) PCT No.: PCT/US24/14497

§ 371 Date: May 27, 2025

Related U.S. Application Data
(60) Provisional application No. 63/443,151, filed on Feb. 3, 2023.

(51) Int. Cl. F16B 2/24; F16B 5/06

(52) U.S. Cl. CPC F16B 2/245; F16B 5/0685

(57) ABSTRACT

For many applications, it is desirable to secure components to one another in an efficient and effective manner. One such application involves assembling building components together, in which a secure connection can be important yet also difficult to achieve. For instance, properly aligning components that are being fastened to one another can be useful for ensuring a proper and aesthetic fit, yet doing so in a fast and efficient manner, can be challenging. Furthermore, ensuring that a resulting structure is water-resistant or watertight can be important for a variety of applications. As a particular example, where holes are made in siding, barrier materials, or other building materials for fastening shutters to a building, such holes may allow water to intrude. These and other matters have presented challenges to the assembly of components, as may relate to building materials and a variety of applications.

### BACKGROUND

For many applications, it is desirable to secure components to one another in an efficient and effective manner. One such application involves assembling building components together, in which a secure connection can be important yet also difficult to achieve. For instance, properly aligning components that are being fastened to one another can be useful for ensuring a proper and aesthetic fit, yet doing so in a fast and efficient manner, can be challenging. Furthermore, ensuring that a resulting structure is water-resistant or watertight can be important for a variety of applications. As a particular example, where holes are made in siding, barrier materials, or other building materials for fastening shutters to a building, such holes may allow water to intrude.

These and other matters have presented challenges to the assembly of components, as may relate to building materials and a variety of applications.

### SUMMARY

Various embodiments are directed to clips, their application and their manufacture. Such embodiments may be useful for assembling building components including shutters.

As may be implemented in connection with a particular embodiment, an apparatus includes a lower component and an upper component. The lower component has first and second opposing planar surfaces facing one another in parallel and being separated by a gap. The opposing planar surfaces are coupled to one another by a connecting piece that is connected to respective edges of the opposing planar surfaces, the connecting piece being configured to hold the opposing planar surfaces in place relative to one another. The upper component is coupled to the lower component and has a curved surface extending upward from the lower portion to a tip and extending laterally in a direction away from the opposing planar surfaces. The curved surface and tip are configured to flex relative to the lower component.

Various methods may be implemented in accordance with one or more aspects characterized herein. In a particular example embodiment, a method for fastening a shutter to siding is carried out as follows. A shutter clip is provided, including a lower component and an upper component. The lower component has first and second opposing planar surfaces facing one another in parallel and being separated by a gap. The opposing planar surfaces are coupled to one another by a connecting piece that is connected to respective edges of the opposing planar surfaces, the connecting piece being configured to hold the opposing planar surfaces in place relative to one another. The upper component is coupled to the lower component and has a curved surface extending upward from the lower portion to a tip and extending laterally in a direction away from the opposing planar surfaces.

The curved surface and tip are configured to flex relative to the lower component. The curved surface is extended between respective siding pieces with the tip extending into a lap connection of the siding pieces, therein securing the shutter clip to the siding pieces. For instance, the tip may be slid between the siding pieces, by bending the curved portion relative to the lower component until the tip latches or locks within the lap connection. A shutter may then be coupled to the shutter clip by engaging a portion of the shutter with the opposing planar surfaces with the portion of the shutter within the gap, therein securing the shutter to the siding.

Other method-based embodiments involve cutting a shutter clip from a piece of metal and bending the cut piece to form the upper and lower components characterized above.

The above discussion/summary is not intended to describe each embodiment or every implementation of the present disclosure. The figures and detailed description that follow also exemplify various embodiments.

### BRIEF DESCRIPTION OF FIGURES

Various example embodiments may be more completely understood in consideration of the following detailed description and in connection with the accompanying drawings, in which:

FIG. 1 is a left front view of a right-side shutter clip, in accordance with an embodiment of the present invention;

FIG. 2 is a right rear view of the shutter clip shown in FIG. 1;

FIG. 3 is a top view of the shutter clip shown in FIG. 1;

FIG. 4 is a bottom view of the shutter clip shown in FIG. 1;

FIG. 5 is a left side view of the shutter clip shown in FIG. 1;

FIG. 6 is a right side view of the shutter clip shown in FIG. 1;

FIG. 7 is a front view of the shutter clip shown in FIG. 1;

FIG. 8 is a rear view of the shutter clip shown in FIG. 1;

FIG. 9 is a right front view of a left-side shutter clip, showing another embodiment of the present invention;

FIG. 10 is a left rear view of the shutter clip shown in FIG. 9;

FIG. 11 is a top view of the shutter clip shown in FIG. 9;

FIG. 12 is a bottom view of the shutter clip shown in FIG. 9;

FIG. 13 is a left side view of the shutter clip shown in FIG. 9;

FIG. 14 is a right side view of the shutter clip shown in FIG. 9;

FIG. 15 is a front view of the shutter clip shown in FIG. 9;

FIG. 16 is a rear view of the shutter clip shown in FIG. 9;

FIG. 17 shows an assembly, in accordance with another embodiment;

FIGS. 18A-18F show respective views of a left side shutter clip, as may be implemented in connection with one or more embodiments, in which:

FIG. 18A depicts a front view;

FIG. 18B depicts a top view;

FIG. 18C depicts a bottom view;

FIG. 18D depicts a left side view;

FIG. 18E depicts a right side view; and

FIG. 18F depicts a rear view;

FIG. 19 shows a top view of a left-side shutter clip, as may be implemented in accordance with one or more embodiments; and

FIG. 20 shows a left-side shutter clip coupled to the right side of a shutter, which may be implemented with various embodiments.

While various embodiments discussed herein are amenable to modifications and alternative forms, aspects thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure including aspects defined in the claims. In addition, the term “example” as may be used throughout this application is by way of illustration, and not limitation.

### DETAILED DESCRIPTION

Aspects of the present disclosure are believed to be applicable to a variety of different types of articles of manufacture, apparatuses, systems and methods involving fastener mechanisms and their applications. In certain implementations, aspects of the present disclosure have been shown to be beneficial when used in the context of fasteners utilized for coupling shutters to structures, such as for coupling shutters adjacent windows or other features in homes and/or other buildings. While not necessarily so limited, various aspects may be appreciated through a discussion of examples using such exemplary contexts.

In various applications, a shutter clip facilitates installation of shutter, such as a vinyl shutter, without utilizing fasteners such as screws or plugs. This may for example involve installing the shutters onto vinyl siding. In some implementations, the shutter clip is configured to insert into a connecting lap portion of vinyl siding at which respective siding components overlap/engage with one another. The shutter clip has a receiving channel configured to lock a shutter in place when the shutter is pushed into the channel. The receiving channel may include fastening components such as teeth or other components that engage with and secure the clip to a shutter. The shutter clip may be configured for implementation for coupling to the top or bottom of a shutter, or to a left or right side of the shutter. Such clips may be hidden from view when the shutter is installed.

In a more particular embodiment, a kit includes a plurality of shutter clips configured to couple to different portions of a shutter. For instance, four shutter clips may be utilized at four corners of a shutter, with each shutter clip being configured for coupling to the shutter at respective locations (e.g., right or left side, top or bottom sides, or a combination thereof).

Certain embodiments are directed to a method of installing shutters using one or more shutter clips as characterized herein. For instance, a top component of a shutter clip may be inserted into a connecting lap of the vinyl siding and a shutter may be pushed into a receiving channel of the shutter clip to lock the shutter in place (e.g., using teeth or other components in the channel). Shutter clips may be used in this manner at corners of a shutter (e.g., four corners of a rectangular shutter), and may be are hidden from view. This method may be carried out without drilling holes into the shutter, vinyl siding, housewrap, or other materials, while also firmly securing the shutter to a structure via the shutter clip(s). Further, this approach may be carried out while preventing the introduction of a moisture entry point (e.g., as may be presented when drilling a hole).

In accordance with a particular embodiment, an apparatus includes a lower component and an upper component. The lower component has first and second opposing planar surfaces facing one another in parallel and being separated by a gap. The opposing planar surfaces are coupled to one another by a connecting piece that is connected to respective edges of the opposing planar surfaces, the connecting piece being configured to hold the opposing planar surfaces in place relative to one another. The upper component is coupled to the lower component and has a curved surface extending upward from the lower portion to a tip and extending laterally in a direction away from the opposing planar surfaces. The curved surface and tip are configured to flex relative to the lower component.

In a more particular implementation the lower and upper components may be implemented using one or more of the following aspects. The opposing planar surfaces may lie in parallel vertical planes. The first opposing planar surface may have an upper portion that extends upwardly above the second opposing planar surface. The connecting piece may extend perpendicularly and horizontally between the opposing planar surfaces. Further, the connecting piece may have one or more of: a planer surface that forms a three-sided enclosure with the opposing planar surfaces, an upper portion that extends upwardly above the three-sided enclosure, an uppermost edge that is shared with a lowermost edge of the curved surface, and a vertical edge of the upper portion that is connected to a vertical edge of the upper portion of the first opposing planar surface. The upper portion of the connecting piece may further include a lower edge that extends at an angle relative to the uppermost edge thereof and upwardly from a portion of the connecting piece adjacent the three-sided enclosure toward the uppermost edge.

In a particular application, the opposing planar surfaces and the connecting piece lie in respective vertical planes. The connecting piece lies in a plane that is perpendicular to the vertical planes in which the opposing planar surfaces lie.

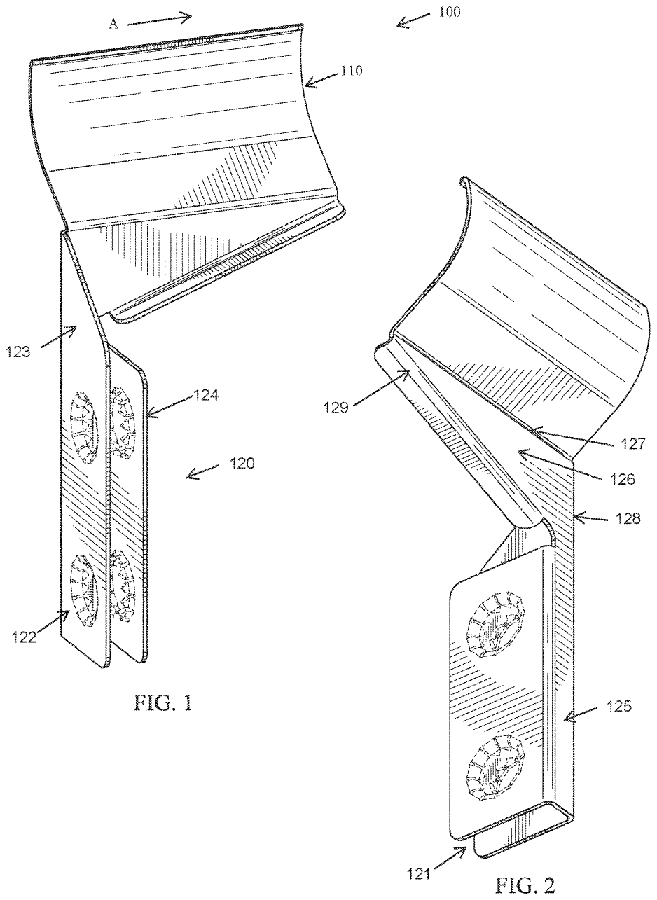

The apparatus may consist of, for example, a planar sheet of material (e.g., metal) that is cut and bent to form the upper and lower components. The respective edges of the planar surfaces that are connected to one another may be bent edges forming a rounded connection (e.g., as shown in FIG. 2).

The opposing planar surfaces may have teeth to engage with a shutter upon insertion of a sidewall of the shutter into a channel defined on three sides by the opposing planar surfaces and the connecting piece. The curved surface may further be configured to slide between respective pieces of siding and engage with the siding and lock the apparatus into place relative to the siding, for example prior to engaging with the shutter.

In certain embodiments, the apparatus (e.g., as an assembly) includes a shutter and respective siding pieces engaged with each other at a lap. The lower and upper components form a shutter clip, the opposing planar surfaces are coupled to a portion of the shutter within the gap, and the curved surface extends between the respective siding pieces with the tip extending into the lap and therein securing the upper component to the siding pieces and securing the shutter to the siding.

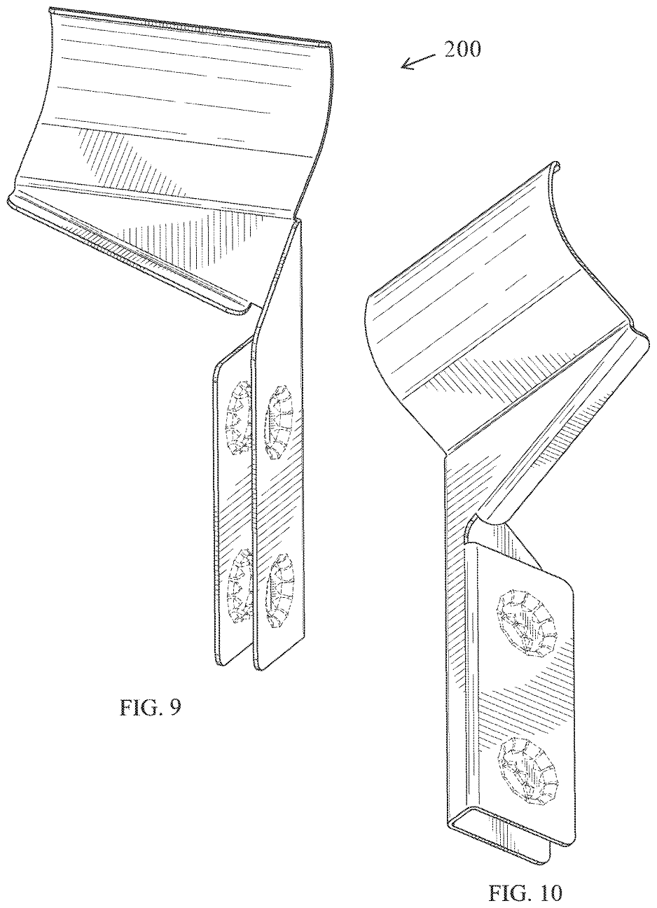

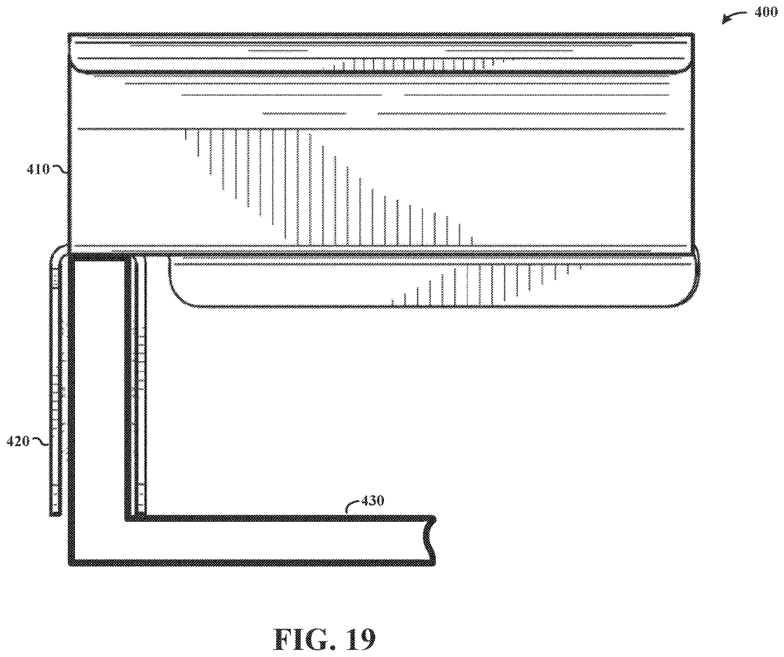

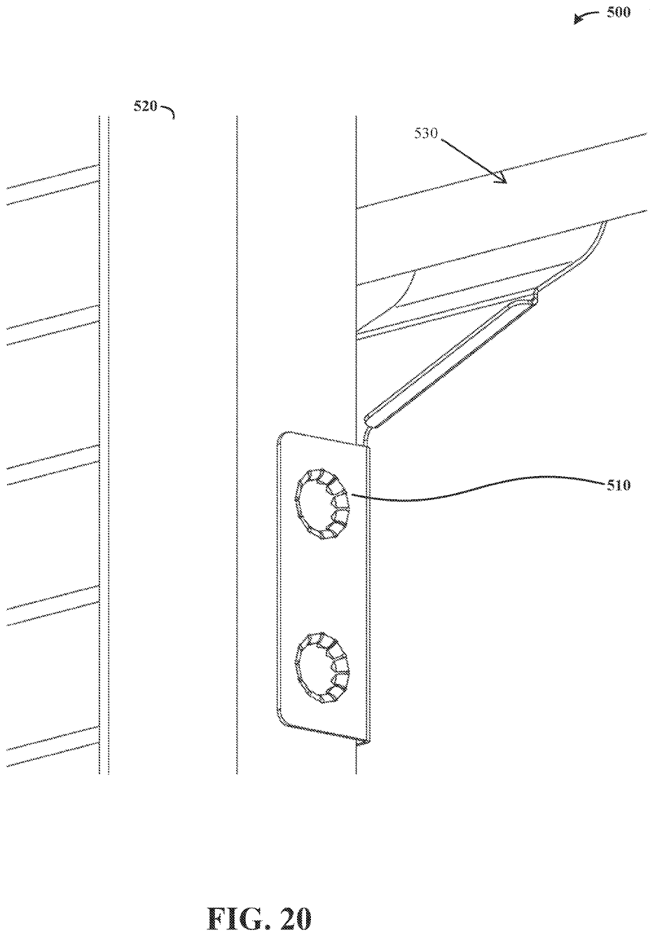

A second shutter clip may further be utilized, for instance having a second one of the lower components and a second one of the upper components that may be mirrored. For instance, a first shutter clip may be implemented in accordance with the apparatus 100 in FIG. 1 and a second shutter clip may be implemented in accordance with the apparatus 200 in FIG. 9. The upper and lower components of the first shutter clip are coupled to a left side of the shutter within the gap, for example as shown in FIG. 19 and/or FIG. 20. The upper and lower components of the second shutter clip are coupled to a right side of the shutter within the gap.

Various methods may be implemented in accordance with one or more aspects characterized herein. In a particular example, a method for fastening a shutter to siding is carried out as follows. A shutter clip is provided, including a lower component and an upper component. The lower component has first and second opposing planar surfaces facing one another in parallel and being separated by a gap. The opposing planar surfaces are coupled to one another by a connecting piece that is connected to respective edges of the opposing planar surfaces, the connecting piece being configured to hold the opposing planar surfaces in place relative to one another. The upper component is coupled to the lower component and has a curved surface extending upward from the lower portion to a tip and extending laterally in a direction away from the opposing planar surfaces. The curved surface and tip are configured to flex relative to the lower component. In some instances, the shutter clip is cut out of a flat piece of metal and the metal is bent to provide the lower and upper components.

The curved surface may be extended between respective siding pieces with the tip extending into a lap connection of the siding pieces, therein securing the shutter clip to the siding pieces. A shutter is coupled to the shutter clip by engaging a portion of the shutter with the opposing planar surfaces with the portion of the shutter within the gap, therein securing the shutter to the siding.

In a more particular embodiment, the method may be carried out using an apparatus (e.g., shutter clip) in which one or more of the following aspects are applied. The opposing planar surfaces may lie in parallel vertical planes. The first opposing planar surface may have an upper portion that extends upwardly above the second opposing planar surface. The connecting piece may extend perpendicularly and horizontally between the opposing planar surfaces, and may have one or more of: a planer surface that forms a three-sided enclosure with the opposing planar surfaces, an upper portion that extends upwardly above the three-sided enclosure, an uppermost edge that is shared with a lowermost edge of the curved surface, and a vertical edge of the upper portion that is connected to a vertical edge of the upper portion of the first opposing planar surface. The portion of the shutter may be engaged with the opposing planar surfaces includes sliding the portion of the shutter into the three-sided enclosure. Coupling the shutter to the shutter clip may include pushing a sidewall of the shutter into the channel, therein locking the shutter in the channel.

In a more particular embodiment, the method involves providing a second one of the shutter clips, the second one of the shutter clips being mirrored relative to said shutter clip. The shutter is coupled to the second shutter clip by engaging a portion of the shutter with the opposing planar surfaces of the second shutter clip, with another portion of the shutter on an opposite side thereof within the gap. Respective sides of the shutter may thus be secured to the siding

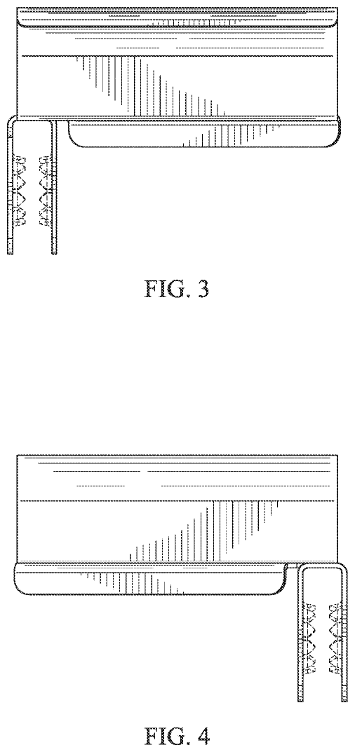

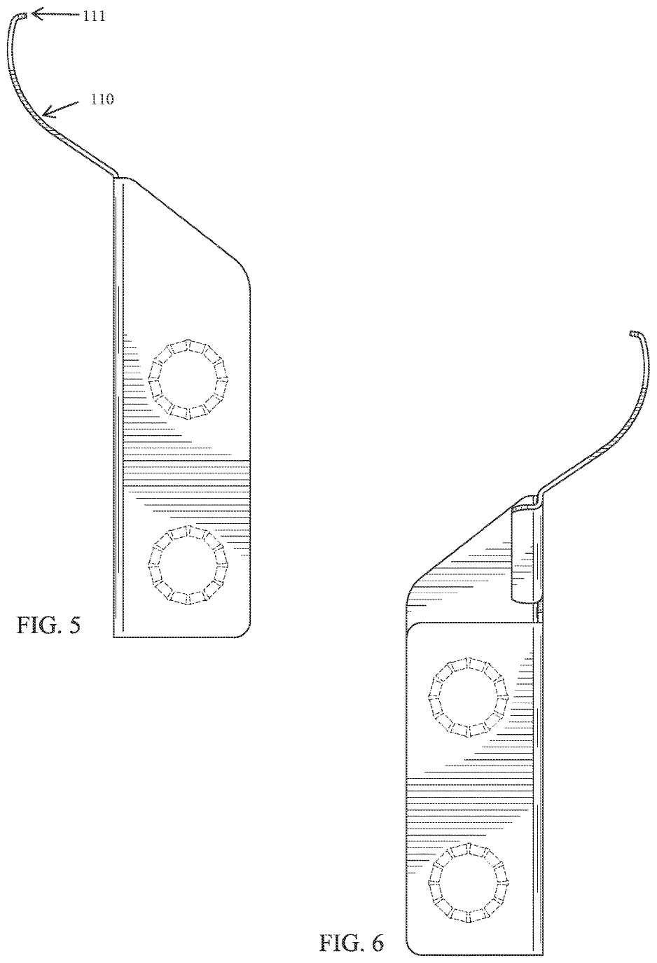

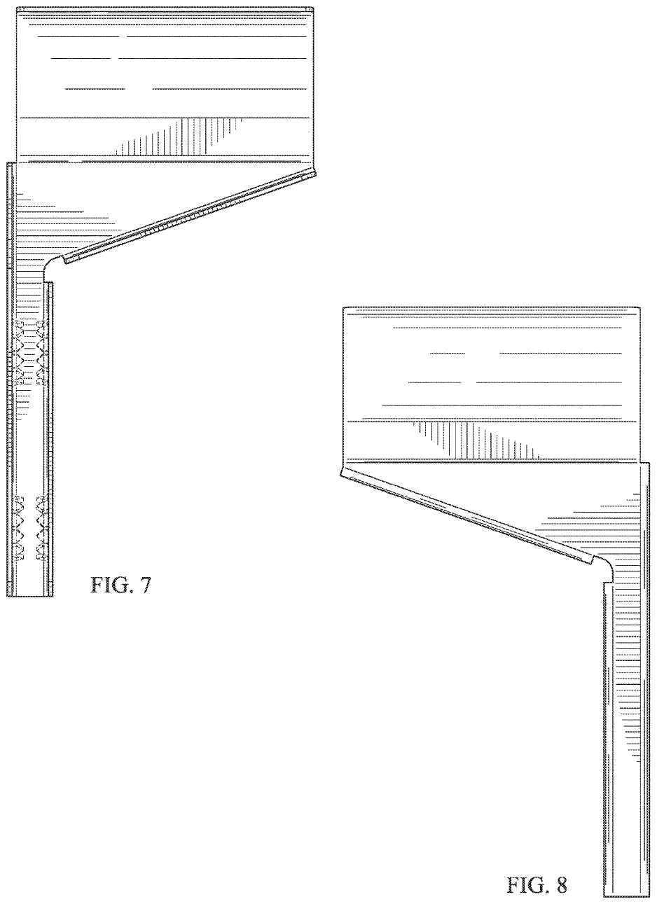

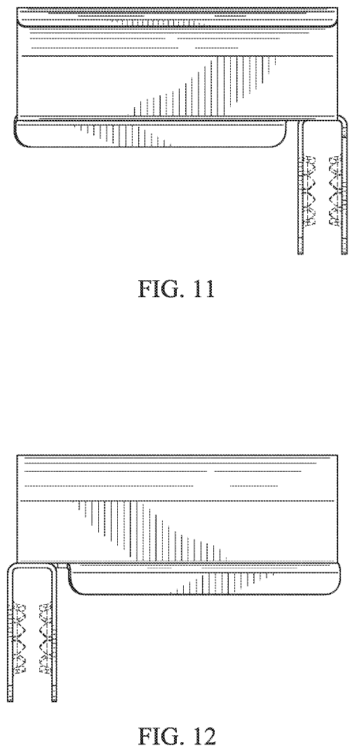

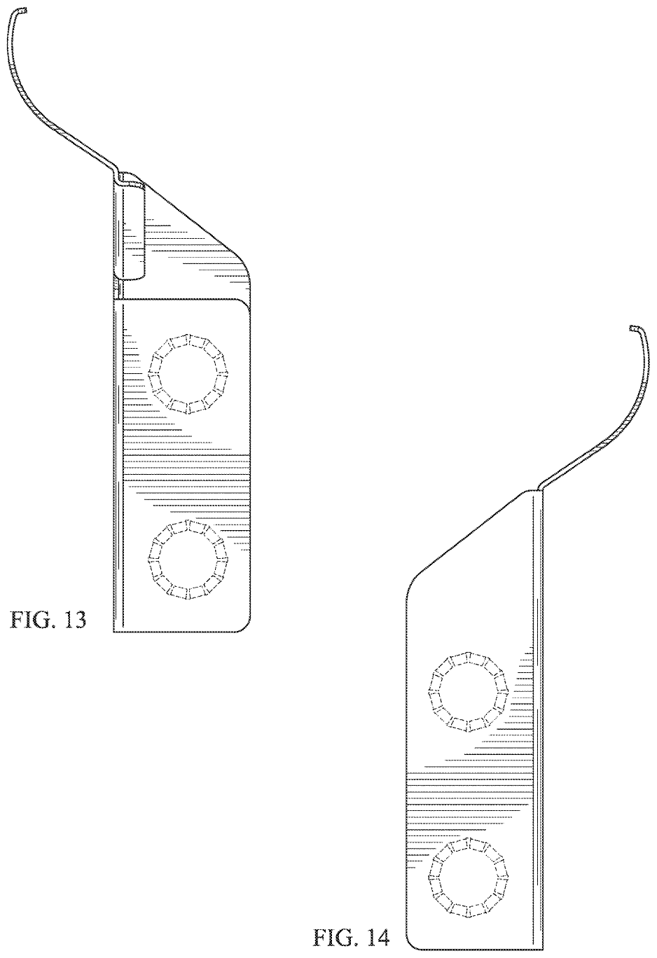

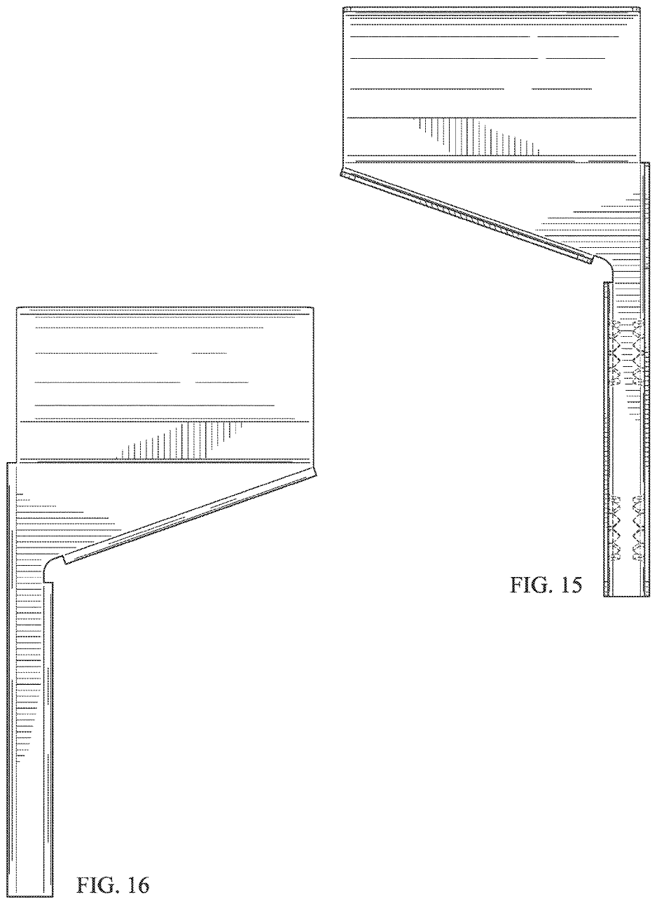

Turning now to the figures, FIGS. 1-8 depict a right-side shutter clip 100, as may be implemented with various embodiments. For the right-side shutter clip 100, FIG. 1 is a left front view, FIG. 2 is a right rear view, FIG. 3 is a top view, FIG. 4 is a bottom view, FIG. 5 is a left side view, FIG. 6 is a right side view, FIG. 7 is a front view and FIG. 8 is a rear view. For the left-side shutter clip 200, FIG. 9 is a right front view, FIG. 10 is a left rear perspective view, FIG. 11 is a top view, FIG. 12 is a bottom view, FIG. 13 is a left side view, FIG. 14 is a right side view, FIG. 15 is a front view, and FIG. 16 is a rear view.

Referring to FIGS. 1 and 2, the shutter clip 100 has an upper curved component 110 configured for insertion into a lap region of siding, and a lower component 120 having a channel 121 into which a shutter may be inserted (e.g., an outer wall of a vinyl shutter).

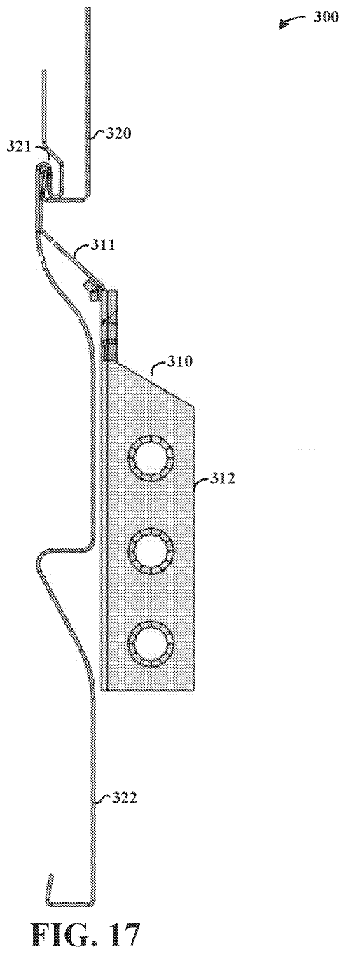

FIGS. 5 and 6 depict the upper curved component 110 in side views, in which a tip 111 is configured for manipulation between interlocked pieces of siding, for instance as shown in FIG. 17. The upper curved component 110 may thus be implemented with a flexible material that facilitates bending of the tip 111 relative to the lower component 120, such that when the lower component 120 is fixed to a shutter, it remains stationary relative to the shutter while the tip 111 may be deployed in a flexed position.

Optional toothed openings are shown, with opening 122 labeled by way of example, and which may be included to engage with and lock the shutter to the shutter clip. In turn, the upper curved component 110 then locks the shutter to building material such as siding. Opening 122 has teeth that may engage with a shutter, and further providing an opening via which a fastener may be inserted (e.g., with the teeth holding the shutter sufficiently in place until a fastener is utilized).

FIGS. 9-16 depict a mirrored left-side shutter clip 200, having components similar to those depicted in FIGS. 1-8, mirrored relative to one another. The various components labeled in FIGS. 1-8 may be applied in FIGS. 9-16, similarly in mirrored form.

The shutter clips depicted in FIGS. 1-16 may be implemented in a variety of manners. Referring to FIG. 1 (and in accordance with a particular embodiment), the lower component 120 includes first (123) and second (124) opposing planar surfaces facing one another in parallel and being separated by the gap 121, and coupled to one another by connecting piece 125 that is connected to respective edges of the opposing planar surfaces (shown by way of example as bent edges). The upper curved component 110 extends upward from the lower portion to the tip 111, and extends laterally in a direction away from the opposing planar surfaces as shown by arrow A. As shown, the opposing planar surfaces may lie in parallel vertical planes, and the first opposing planar surface 123 has an upper portion that extends upwardly above the opposing planar surface 124. The connecting piece 125 may extend perpendicularly and horizontally between the opposing planar surfaces as shown at 126. The connecting piece may have a planer surface (where the arrow from 125 points) that forms a three-sided enclosure with the opposing planar surfaces (and makes the gap 121), and an upper portion at 126 that extends upwardly above the three-sided enclosure. An uppermost edge 127 of the upper portion 126 may be shared with a lowermost edge of the upper curved surface 110, and a vertical edge 128 of the upper portion may be connected to a vertical edge of the upper portion of the first opposing planar surface. The upper portion of the connecting piece may further have a lower edge 129 that extends at an angle relative to the uppermost edge thereof and upwardly from a portion of the connecting piece adjacent the three-sided enclosure toward the uppermost edge.

FIG. 17 shows an assembly 300, in accordance with another embodiment. A shutter clip 310 has an upper component 311 configured to engage with siding, and a lower component 312 configured to engage with and lock to a shutter. Respective horizontal siding portions 320 and 322 are depicted engaged with one another at a lap region 321. The curved component 311 of the shutter clip may be inserted into the lap region 321 to engage with the siding, and a shutter may be inserted into the lower component 312. The shutter clip 310 may, for example, be implemented utilizing a clip such as shown in FIGS. 1-8 (or mirrored in FIGS. 9-16), for instance with curved component 110 inserted into the lap region 321 and the lower component 120 engaged with a shutter.

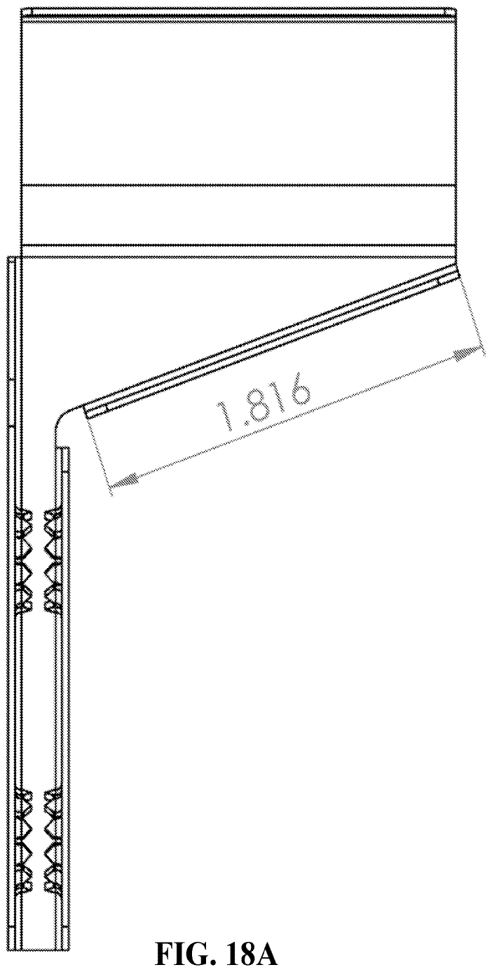

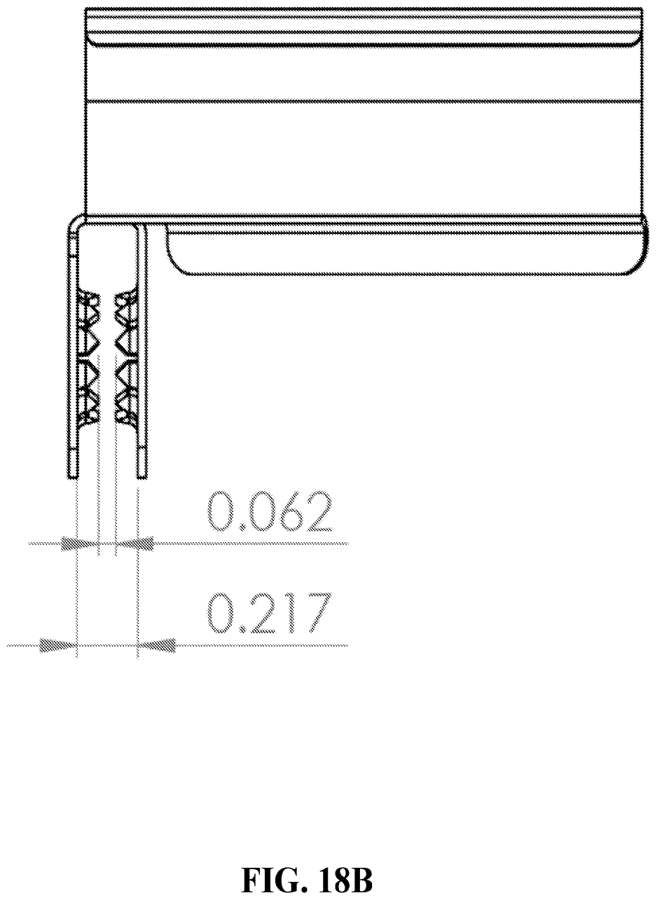

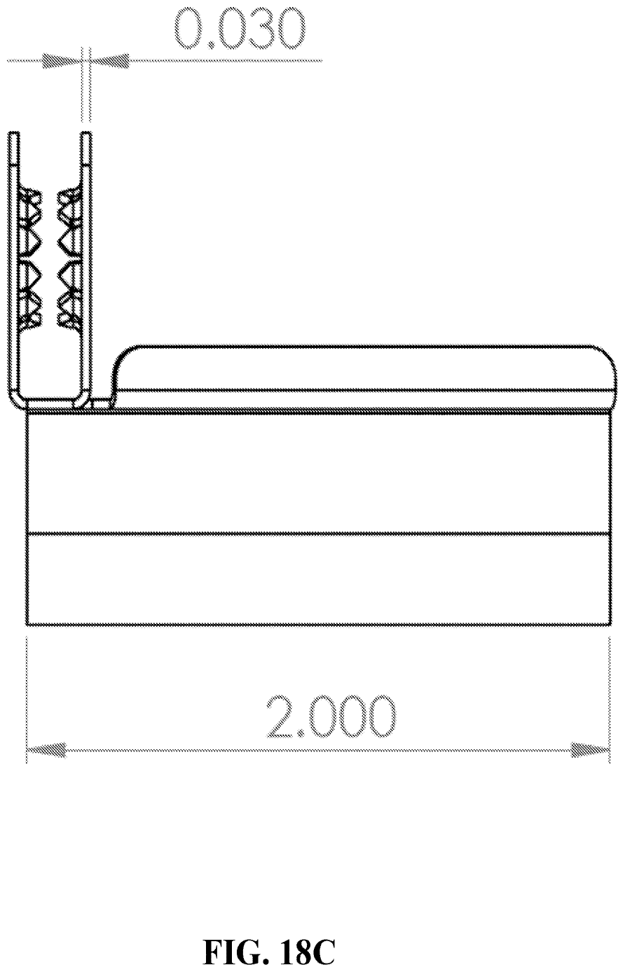

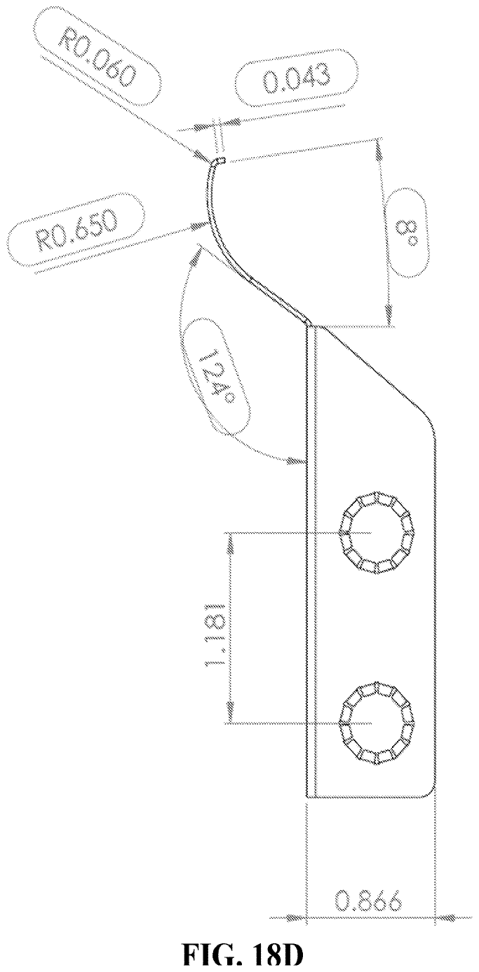

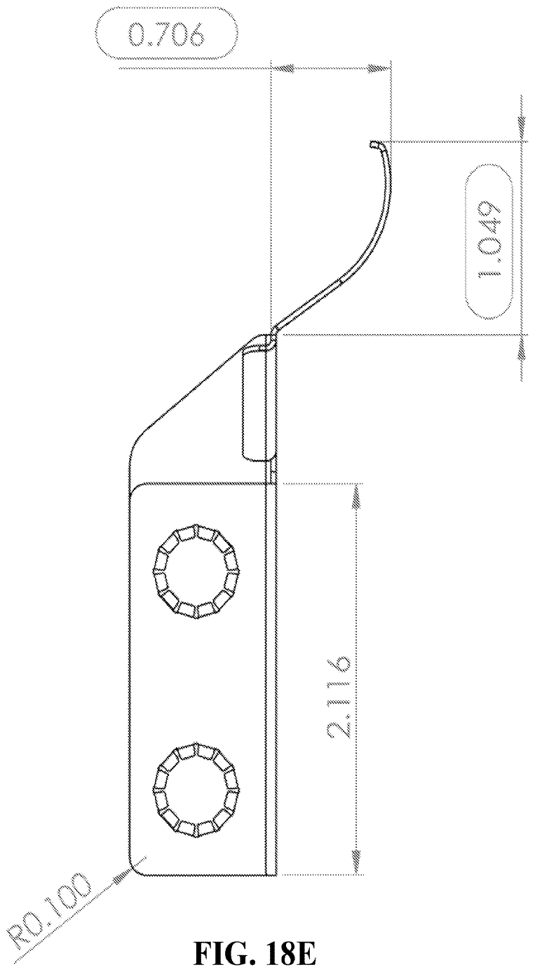

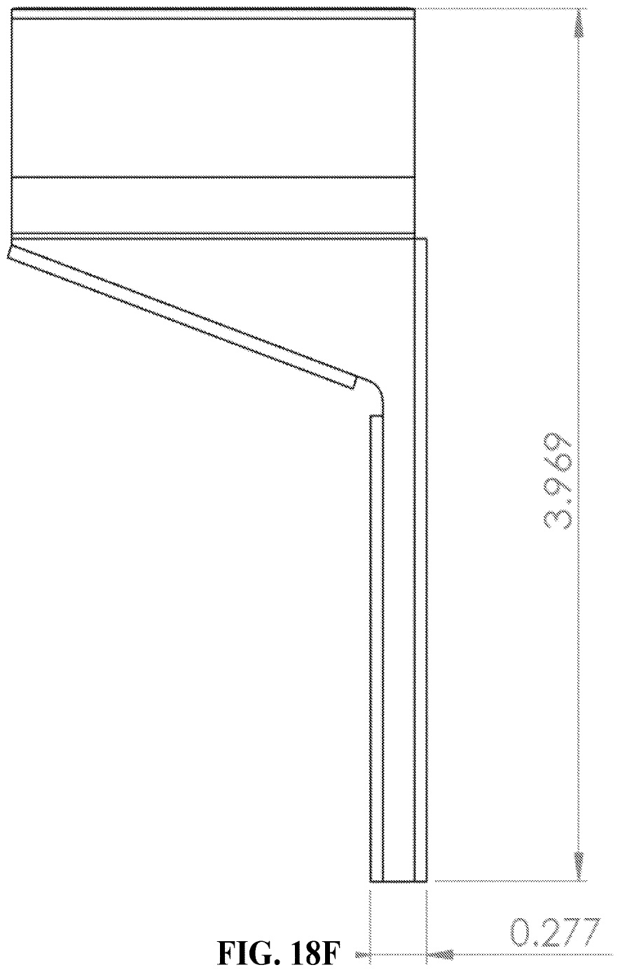

FIGS. 18A-18F show respective views of a left side shutter clip 1800, as may be implemented in connection with one or more embodiments. Exemplary dimensions are shown, and may be scaled to suit particular applications. FIG. 18A depicts a front view, FIG. 18B depicts a top view, FIG. 18C depicts a bottom view, FIG. 18D depicts a left side view, FIG. 18E depicts a right side view, and FIG. 18F depicts a rear view. The shutter clip 1800 may be implemented in accordance with the shutter clip depicted in FIGS. 9-16. Further, similar dimensions may be utilized in mirrored format for a right side shutter clip, for example as depicted in FIGS. 1-8.

FIG. 19 shows a top view of a left-side shutter clip 400, as may be implemented in accordance with one or more embodiments. The shutter clip 400 has an upper curved component 410 and a lower component 420 configured to engage with a shutter 430, which is depicted in a cross-sectional cut-away view. The shutter clip 400 may be implemented, for example, in accordance with the left-side shutter clip depicted in FIGS. 9-16 and/or with the left-side shutter clip shown in FIGS. 18A-18F.

FIG. 20 shows a left-side shutter clip 500 coupled to the right side of a shutter 520 for illustrative purposes (so that the shape of the clip may be visualized directly), as may be implemented in accordance with various embodiments. The shutter clip 500 may thus be implemented with a left side of the shutter 520. A sidewall of the shutter has been inserted into the lower region of the shutter clip 500, for instance in a manner as shown in FIG. 19. The upper component of the shutter clip 500 is engaged with a lap on siding 530 as shown. When implemented on a left side of the shutter 520, the shutter clip 500 is located behind the shutter and generally hidden from view. As such, the view in FIG. 20 is illustrative.

Various embodiments are directed to aspects depicted in U.S. Provisional Patent Application Ser. No. 63/443,151, entitled “SHUTTER CLIP APPARATUSES, ASSEMBLIES AND METHODS” and filed on Feb. 3, 2023, to which benefit is claimed and which is fully incorporated herein by reference. For instance, referring to Appendix A therein, various embodiments are directed to shutter clips as shown, including clips with gripper holes and a screw hole for hard mounting, for instance using a ½″ self-tapping screw for gutters. The dimensions shown may be utilized for particular embodiments.

Based upon the above discussion and illustrations, those skilled in the art will readily recognize that various modifications and changes may be made to the various embodiments without strictly following the exemplary embodiments and applications illustrated and described herein. For example, the shutter clips as shown can be made with fewer or more openings, wider or thinner openings to suit the insertion of shutters having walls of certain widths, or may be utilized with variations on respective sides (e.g., a pair of right and left side clips need not be mirrored as shown in FIGS. 1-16). In addition, while reference is made to orientation characteristics such as “above,” “upper,” and “lower,” these relative orientations are illustrative such that the noted components could be positioned differently, for instance in which the clips as shown in the figures may be flipped vertically or rotated laterally. Such modifications do not depart from the true spirit and scope of various aspects of the invention, including aspects set forth in the claims.

What is claimed is:

1. An apparatus comprising:
a lower component having first and second opposing planar surfaces facing one another in parallel and being separated by a gap, the opposing planar surfaces being coupled to one another by a connecting piece that is connected to respective edges of the opposing planar surfaces, the connecting piece being configured to hold the opposing planar surfaces in place relative to one another;
an upper component coupled to the lower component, the upper component having a curved surface extending upward from the lower portion to a tip and extending laterally in a direction away from the opposing planar surfaces, the curved surface and tip being configured to flex relative to the lower component.

2. The apparatus of claim 1, wherein:
the opposing planar surfaces lie in parallel vertical planes;
the first opposing planar surface has an upper portion that extends upwardly above the second opposing planar surface;
the connecting piece extends perpendicularly and horizontally between the opposing planar surfaces;
the connecting piece has: a planer surface that forms a three-sided enclosure with the opposing planar surfaces, an upper portion that extends upwardly above the three-sided enclosure, an uppermost edge that is shared with a lowermost edge of the curved surface, and a vertical edge of the upper portion that is connected to a vertical edge of the upper portion of the first opposing planar surface.

3. The apparatus of claim 2, wherein the upper portion of the connecting piece has a lower edge that extends at an angle relative to the uppermost edge thereof and upwardly from a portion of the connecting piece adjacent the three-sided enclosure toward the uppermost edge.

4. The apparatus of claim 1, wherein the opposing planar surfaces and the connecting piece lie in respective vertical planes, the connecting piece lying in a plane that is perpendicular to the vertical planes in which the opposing planar surfaces lie.

5. The apparatus of claim 1, wherein the apparatus consists of a planar sheet of material that is cut and bent to form the upper and lower components.

6. The apparatus of claim 1, wherein the respective edges of the planar surfaces that are connected are bent edges forming a rounded connection.

7. The apparatus of claim 1, wherein the opposing planar surfaces have teeth configured to engage with a shutter upon insertion of a sidewall of the shutter into a channel defined on three sides by the opposing planar surfaces and the connecting piece.

8. The apparatus of claim 7, wherein the curved surface being configured to slide between respective pieces of siding and engage with the siding and lock the apparatus into place relative to the siding.

9. The apparatus of claim 1, further including a shutter and respective siding pieces engaged with each other at a lap, wherein:
the lower and upper components form a first shutter clip;
the opposing planar surfaces are coupled to a portion of the shutter within the gap; and
the curved surface extends between the respective siding pieces with the tip extending into the lap and therein securing the upper component to the siding pieces and securing the shutter to the siding.

10. The apparatus of claim 9, further including a second shutter clip having a second one of the lower components and a second one of the upper components, wherein
the first and second shutter clips are mirrored relative to one another;
the upper and lower components of the first shutter clip are coupled to a left side of the shutter within the gap; and
the upper and lower components of the second shutter clip are coupled to a right side of the shutter within the gap.

11. A method for fastening a shutter to siding, the method comprising:
providing a shutter clip including:
a lower component having first and second opposing planar surfaces facing one another in parallel and being separated by a gap, the opposing planar surfaces being coupled to one another by a connecting piece that is connected to respective edges of the opposing planar surfaces, the connecting piece being configured to hold the opposing planar surfaces in place relative to one another; and
an upper component coupled to the lower component, the upper component having a curved surface extending upward from the lower portion to a tip and extending laterally in a direction away from the opposing planar surfaces, the curved surface and tip being configured to flex relative to the lower component;
extending the curved surface between respective siding pieces with the tip extending into a lap connection of the siding pieces, therein securing the shutter clip to the siding pieces;
coupling a shutter to the shutter clip by engaging a portion of the shutter with the opposing planar surfaces with the portion of the shutter within the gap, therein securing the shutter to the siding.

12. The method of claim 11, wherein:
the opposing planar surfaces lie in parallel vertical planes;
the first opposing planar surface has an upper portion that extends upwardly above the second opposing planar surface;
the connecting piece extends perpendicularly and horizontally between the opposing planar surfaces;
the connecting piece has: a planer surface that forms a three-sided enclosure with the opposing planar surfaces, an upper portion that extends upwardly above the three-sided enclosure, an uppermost edge that is shared with a lowermost edge of the curved surface, and a vertical edge of the upper portion that is connected to a vertical edge of the upper portion of the first opposing planar surface; and
engaging the portion of the shutter with the opposing planar surfaces includes sliding the portion of the shutter into the three-sided enclosure.

13. The method of claim 12, wherein coupling the shutter to the shutter clip includes pushing a sidewall of the shutter into the channel, therein locking the shutter in the channel.

14. The method of claim 11, wherein providing the shutter clip includes cutting the shutter clip out of a flat piece of metal and bending the metal to provide the lower and upper components.

15. The method of claim 11, further including providing a second one of the shutter clips, the second one of the shutter clips that is mirrored relative to said shutter clip, further including coupling the shutter to the second shutter clip by engaging a portion of the shutter with the opposing planar surfaces of the second shutter clip with another portion of the shutter on an opposite side thereof within the gap, therein securing respective sides of the shutter to the siding.
